(19) United States
(12) Patent Application Publication
(10) Pub. No.: US 2018/0174176 A1
(43) Pub. Date: Jun. 21, 2018

(54) VARIABLE RATIO AWARD SELECTION

(71) Applicant: Erika Reed, Moraga, CA (US)

(72) Inventor: Erika Reed, Moraga, CA (US)

(21) Appl. No.: 15/384,638

(22) Filed: Dec. 20, 2016

(51) Int. Cl. G06Q 30/02; G06Q 20/20

(52) U.S. Cl. CPC G06Q 30/0212; G06Q 30/0238; G06Q 20/202

(57) ABSTRACT

Method to variably select and score a subset of transactions that meet a qualifying criteria with the purpose of triggering awards to participating card holder(s) and sponsors. The qualifying criteria are entered via a portal that allows an award sponsor to set the qualifying criteria as well as setting other factors that may include the award rate, award amounts, and total value of awards to be applied to a particular campaign. The recipients of the awards are selected using an algorithm to improve the impact of the award experience and increase purchasing behavior.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Incentives for a card holder to use a particular financial instrument or payment vehicle may not be effective when a small across-the-board percentage is offered on transactions. For example, a 1% reward, or $0.50 on a $50.00 purchase may not be incentivizing enough to create a change in behavior for a purchaser to choose one financial instrument over another. Similarly, incentives for a merchant to sponsor a particular rewards program or option may not be as compelling when required to fund rewards for all transactions that qualify. For example, a 1% reward, or $0.50 on a $50.00 purchase may become costly to fund in aggregate terms in relation to net economic value created for the merchant.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In some embodiments, a qualifying purchase, for example using a particular financial instrument, may be selected for a chance to receive an award at the time of the transaction. The award may be equal to the value of the current transaction or may be less than or more than that of the current transaction. An award sponsor can design the award at a portal that provides tools for setting requirements for a qualifying purchases, award amounts, award frequency, and total award spend. In an embodiment, a subset of qualifying transactions are variably selected for the award at a point in the transaction processing flow that allows screening of the transaction. Per the discretion of the sponsor merchant, the execution of the award then can be configured to occur in near real time during the point of purchase or after the purchase transaction. The merchant or service provider may also be given a portion of such an award as an incentive to select a particular payment instrument.

### BRIEF DESCRIPTION OF THE DRAWINGS

FIG. 1 illustrates a block diagram of system elements used in variable ratio award selection in accordance with the current disclosure;

FIG. 2 is a block diagram illustrating an award processor, one of the system elements found in FIG. 1;

FIG. 3 is a block diagram illustrating hardware elements of portal used in configuring variable ratio award selection;

FIG. 4 is an illustration of an exemplary user interface for the portal of FIG. 4;

FIG. 5 depicts a merchant terminal, one of the system elements found in FIG. 1; and

FIG. 6 is a flowchart of a method of variable ratio award selection.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

There is a body of thought that a consumer may be more motivated to change behavior at the possibility of a big payoff compared to the certainty of a small payoff. A sponsor of a campaign to increase traffic, improve brand awareness, or improve customer loyalty may fund awards for certain transactions up to, or even beyond, the full amount of a purchase in lieu of an across the board percentage or fixed amount earned or rebated or points earned. Per the discretion of the sponsor, the variable selection of a transaction and fulfillment of the award may be made in real time as the transaction is being processed. In various embodiments, the sponsor of the award program may also receive an award in order to encourage customers to use a particular financial product for transactions or to make a qualifying purchase.

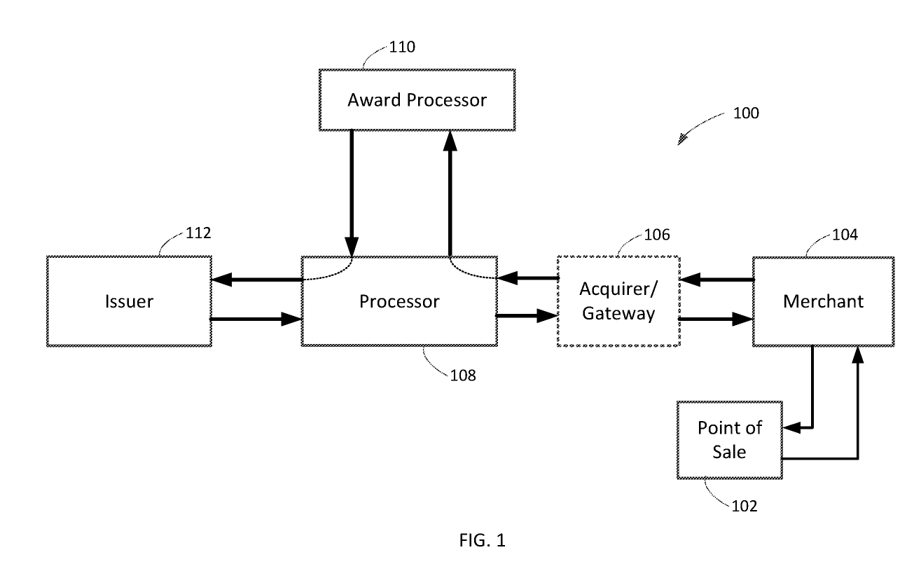

FIG. 1 generally illustrates one embodiment of a system 100 used to process a transaction involving variable ratio award selection, that is, for variably selecting a subset of purchase transactions to grant awards. As in a standard card present or card not present transaction, the purchase transaction may begin at a point-of-sale device (POS) 102 associated with a merchant 104 or at a merchant website or mobile app. The POS 102 may include a card reader for either magnetic stripe or chip cards. The POS 102 may also include a ‘tap’ entry for near-field communication (NFC) with, for example, a smart phone. In other embodiments, the POS 102 may be equipped to receive data for a payment account such as a digital wallet. The merchant 104 may populate the POS 102 with a transaction amount and the POS 102 is then used by a customer to provide payment information, such as a personal account number (PAN) or a token representing a PAN. In an embodiment, the token may be associated with the PAN but may only be valid at that particular merchant 104 or may have a limited life span in order to improve security and protect from loss due to theft.

The merchant 104 may receive the payment information including a customer identifier and add additional information including the product details, if required, a merchant identifier, a POS identifier, a transaction type (e.g., card present) to create a transaction record. The merchant 104 may pass transaction record along to an acquirer 106. In the case of an online transaction, a gateway may be involved with or instead of the acquirer 106. The acquirer 106, if present, may perform some level of processing and pass the transaction to a processor 108. The processor 108 may substitute the token for a PAN, if needed, and, in one scenario, may pass the transaction record to the issuer 112 for approval. In the illustrated embodiment, the processor 108 may pass the transaction record to an award processor 110, where steps may be taken to determine if the current transaction qualifies for an award, and if it does, whether an award will be issued and a value of the award. The steps at the award processor 110 are discussed in more detail below.

In one case, the award processor 110 makes no changes to a transaction record which is returned to the processor 108 and ultimately forwarded to an issuer 112. The issuer may approve or deny the purchase transaction and return an appropriate message via the processor 108, the acquirer 106 if present, to the merchant 104. In some cases, the merchant 104 may forward a result message to the point-of-sale device 102. In another case, the award processor 110 may alter the transaction amount and, if implemented, populate the appropriate field information of the transaction record. In other embodiments, the award processor 110 may be responsible for settling the award amount with the sponsor.

In still other embodiments, the functions of the award processor 110 may be performed in part or in whole by the processor 108, the acquirer 106, or the issuer 112. In other configurations, the award processor 110 may be a separate entity but in line with the transaction flow. For example, the award processor 110 may lie between the acquirer 106 and the processor 108. In each of these configurations, the basic functions described below with respect to campaign set up, transaction selection, and award presentation may be present in some form.

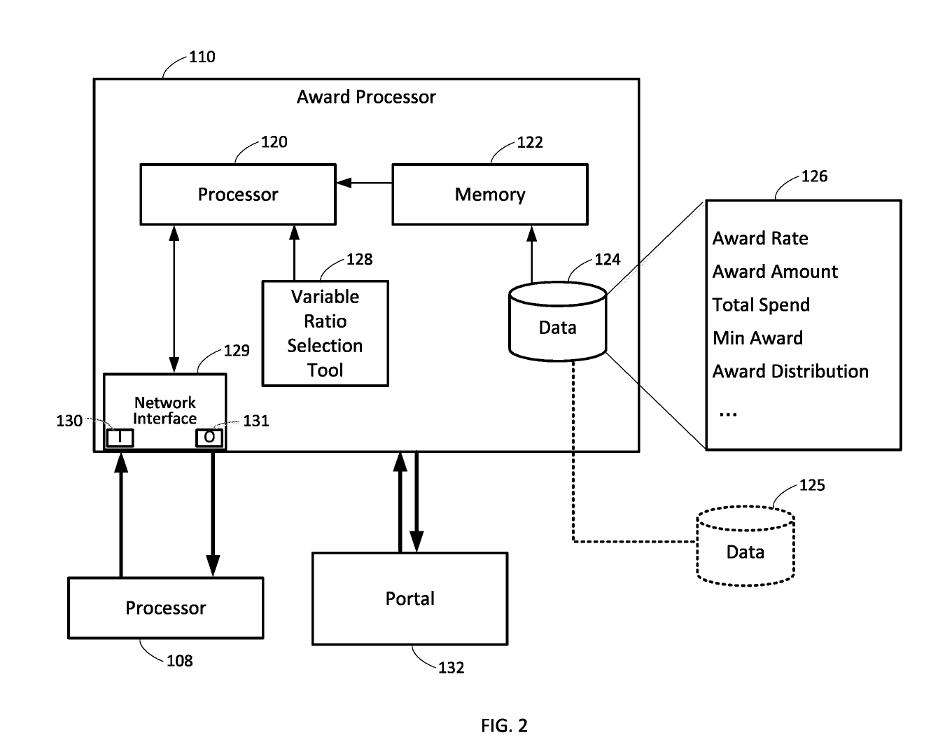

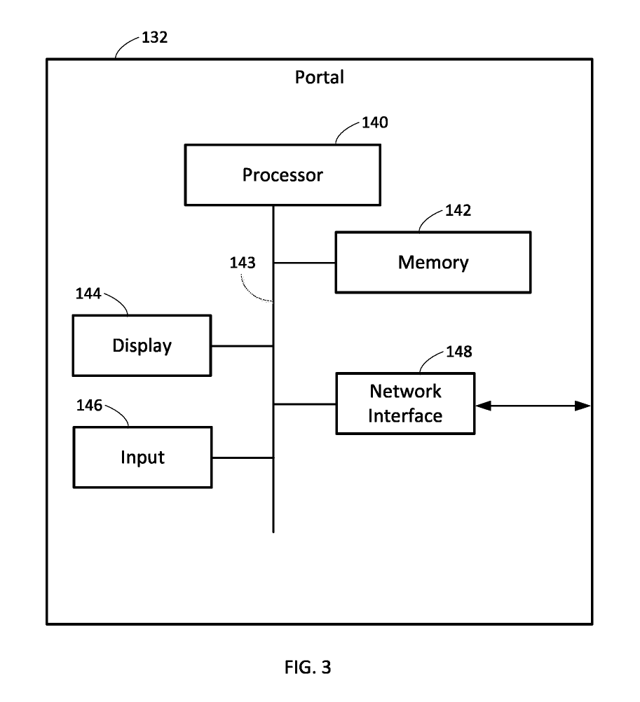

FIG. 2 illustrates an embodiment of the award processor 110. The award processor 110 may include a processor 120 and memory 122 that itself may include a database 124 storing specific information related to variable ratio award selection. The database 124 may include fields and values configurable by the sponsor 126 for an award rate, an award amount, a total spend, a minimum award, and an award distribution, among others. The database 124 may optionally map with other internal and external data sources 125 to support scoring the potential impact of the award. More specifically, the database may be used not only to configure parameters related to operating a campaign, but to evaluate impact and effectiveness during and after the campaign. These fields are discussed in more detail below with respect to FIG. 3.

A variable ratio selection tool 128 may be used in the selection process by generating selections of transactions and scoring them to receive an award. In an embodiment, the selection may be made according to one of several algorithms designed to improve market awareness, brand loyalty as well as the award's propensity to impact that specific card holder. For example, scoring may be supported by external data sources to determine what size award is likely to influence future spend or how active or referential a card holder may be on social media. In another example, a Skinner variable rate selection ratio criteria may be applied so that transactions may be selected at a constant rate, e.g., every tenth or every one hundredth transaction receives an award. In another embodiment, an interval criteria may be applied so that a transaction may be selected after a fixed period of time, for example, every 10 minutes. As opposed to mere random selection, where award selections may be appear in groups or have relatively long periods where no award selection is made, the rate or interval selection may provide a more even distribution of award selection. In an age of social media and sharing of fortunate events, this may even the flow positive messages to friends and relatives of recipients related to a sponsors efforts for brand awareness.

In contrast to a fixed 1% or 2% of all purchases made, a user may be more highly motivated to remain loyal to one brand when a less frequent award of a perceived high value is presented. This may be particularly true when the award is made at the time of purchase when there is a likelihood that family, friends, or a merchant may be may be present to witness the award, as opposed to opening a monthly statement to see a fixed percentage of points or monetary value in the form of a rebate.

In an embodiment, the pool selection may also be a factor when creating a campaign. That is, if a relatively small pool of potential transactions is selected the impact of an award may have a more lasting effect, for example, when a particular user may be selected more than once in a campaign. To illustrate, if a pool is limited to 15 individuals, a single individual may have a significant chance of receiving two awards in a relatively short period of time. Even though the award may not be repeated for a long time, the individual may remain loyal to a brand over a longer period of time.

The selection of the pool of transactions may be as highly granular as desired, including those for a particular merchant or merchants, a particular geographic shopping area, a particular geographic residence area, social media groups, award registration status, transaction amounts or other criteria. When a particular pool of transactions is large, the selection of awards may appear random on an individual who only is selected one time, but the overall effect on the group may be to reinforce a desired brand loyalty through the use of the high value award and resulting social media spread.

A network interface 129 may include an input 130 and an output 131 that support communication with external entities, such as the processor 108 during operation or a portal 132 during campaign configuration.

A portal 132 used to set up a campaign may be illustrated in FIG. 3. The portal 132 may include a processor 140 coupled to a memory 142 via a data bus 143. The portal 132 may include a display 144 and an input device 146. In different embodiments, the input device 146 may be a touch screen, a mouse/keyboard, track pad, etc. A network interface 148 may connect the portal 132 to the award processor 110 as illustrated in FIG. 2 or may connect via a wide area network, such as the Internet.

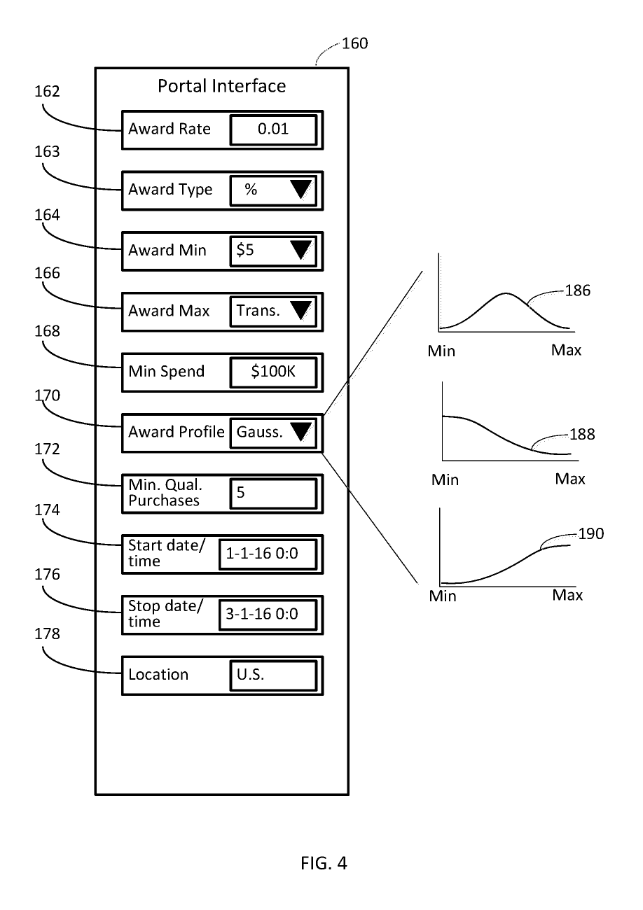

An embodiment of a user interface 160 that may be presented by the display 144 of the portal 132 is depicted in FIG. 4. The user interface 160 may include various fields that can be set in relation to a campaign. However, fewer or more fields may be used for different campaigns based on the complexity of the qualifications for transactions, making awards, merchant awards, settlement, etc. An award rate 162 may be set in order to control the rate at which winners are selected. As discussed above, the award rate may select a rate at which qualified transactions are selected. In another embodiment, the award rate may specify a time interval between selections from the qualified transactions. An award type 163 may be a percentage or an absolute value in various embodiments. Another award type 163 may allow the award to be randomly selected within a range of criteria. In yet another embodiment, a scoring process may be applied to determine an amount of the award that is likely to influence future behavior. An award minimum 164 may specify the minimum award amount to be granted to a selected transaction. In an embodiment, transactions may be filtered by a minimum transaction amount so that there is a guarantee that the minimum award amount will not exceed the transaction value. In other embodiments, the qualifications for a transaction to be put in the ‘pool’ may not include a transaction amount and an award of more than the transaction amount may be possible.

An award minimum 164 may specify a lower limit on the award amount. In an embodiment, the award minimum may be set to a dollar amount. In another embodiment, the award minimum may be set to a percentage of the transaction amount. An award maximum field 166 may specify an upper limit on the award amount, such as the value of the transaction. In various embodiments, there may be an additional field available to cap the award should a particular selected transaction have an extraordinarily high value. A minimum spend 168 value may specify the smallest amount a sponsor is willing to invest in a particular campaign. The value of the minimum spend 168 may be checked for each selected transaction. When a particular transaction causes the minimum spend 168 to be exceeded, the campaign may be ended.

An award profile 170 is one example of how the minimum spend 168 may be distributed among transactions. For example, profile 186 may be a Gaussian distribution of award amounts between the award minimum 164 and the award maximum 166. In the case where the maximum is the transaction value, using this guide, most awards would be for about 50% off the total. Profiles 188 and 190 may illustrate two other distributions that place most of the awards either at the minimum or maximum, respectively. Of course, the ways in which the total spend may be allocated is virtually limitless and these are simply examples for the sake of illustration.

In some embodiments, transactions may only be considered for an award after some qualifying events or milestones are reached. In one embodiment, a particular customer may need to meet a minimum number of qualifying purchases using a particular financial instrument before being eligible for an award, as designated by the setting for qualifying purchases 172. In another embodiment, the customer may be required to belong to a certain population, such as having a designated bank card. In a yet another embodiment a total value of transactions using the financial instrument may need to be met before being eligible for an award. While only a transaction value above the award minimum 164 may be required in a different embodiment. As with the award profile 170 above, there are numerous options for qualifying eligibility and a transaction may be eligible for selection only after these eligibility requirements are met. Once a transaction is eligible for selection, any of a number of techniques may be used to determine if the transaction will be granted an award, including random selection, a non-random rate or non-random interval selection discussed above, or another selection technique.

A start date/time 174 and stop date/time 176 may be used to specify the dates and times for the campaign. As noted above, a campaign may be ended when the minimum funds have been committed even if the end date has not been reached. Other fields, such as location 178 may be available for narrowing the campaign focus to a particular set of zip codes, area codes, commerce regions, etc.

The portal 132 offers sponsors an easy way of designing a campaign and specifying limits. It is envisioned that the elements shown in the user interface 160 of the portal 132 are themselves selectable from a broader list of fields that may include merchants, brands, and other configurable selections so that a campaign may be customized and saved for future reuse directly or with modifications such as location 184 or total spend 168.

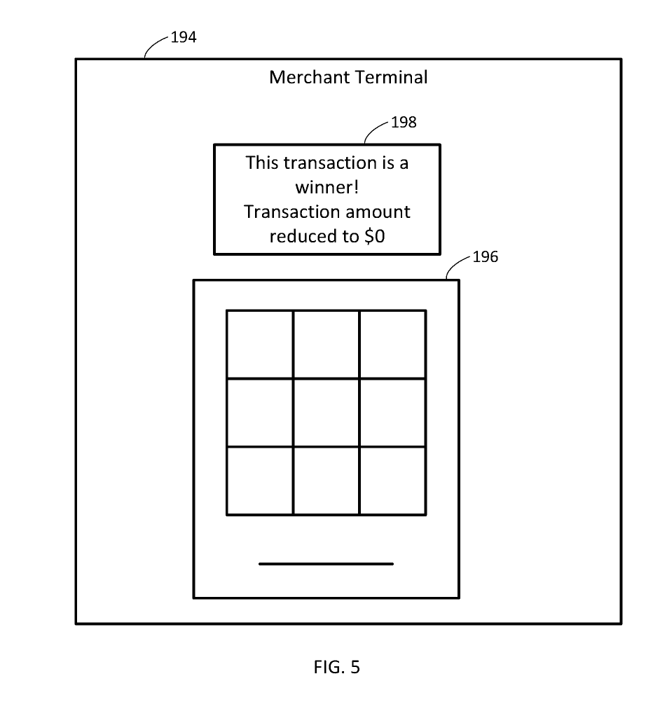

FIG. 5 is an illustration depicting a merchant terminal 194 such as may be used in a purchase transaction at merchant 104. The merchant terminal 194 may include an input area 196 for swiping, dipping, or tapping a card, or entering data on a keyboard. A display 198 may be used for normal transaction communication, such as “approved.” As illustrated in FIG. 5, the display 198 may also be used to inform the merchant and purchaser that a transaction has been selected for an instant award. In other embodiments, the award notification may be documented via a printed notification. For example, the award notification may be printed on the receipt or printed at the same time as the receipt.

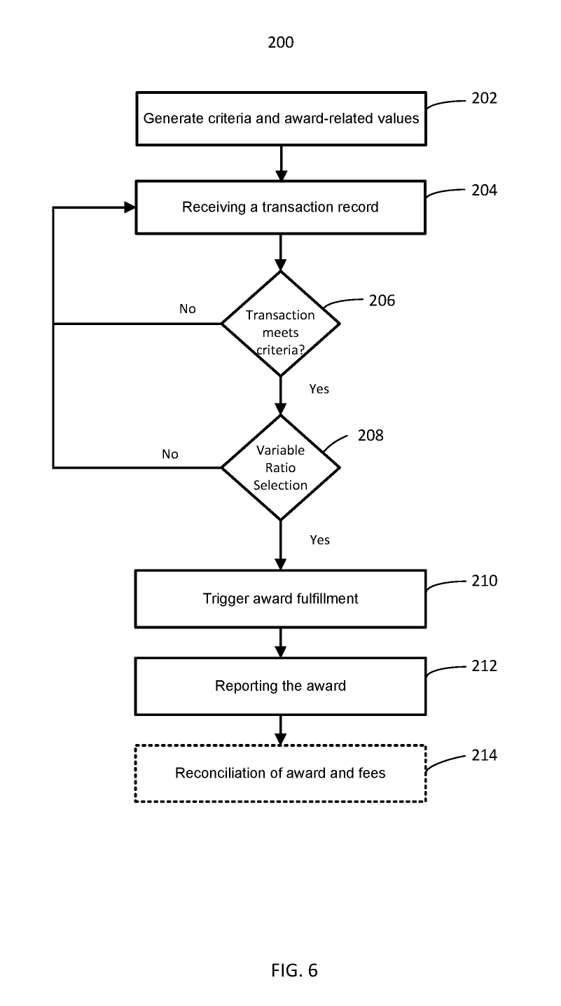

A method 200 of selecting a purchase transaction for an award may be illustrated in FIG. 6. At block 202, a selection of criteria and award values may be received via a portal 132. The criteria may include qualifications for a purchaser, qualifications for a financial instrument, qualifications for a particular transaction, etc., as discussed above.

A transaction record for a purchase transaction may be received at block 204 and at block 206 the transaction record may be compared to the criteria developed at block 202. A decision may be made at block 206 whether the relevant criteria have been met for the transaction to be considered for an award. If no, execution continues at block 204 and another transaction record is processed. If yes, execution continues at block 208 where a selection process is used to determine if the current transaction record will receive an award. As discussed above, this may involve determining at a variable ratio selection tool 128 whether the current transaction meets the criteria for selection.

When the variable ratio selection tool 128 determines that the current transaction record is not to be selected, execution follows the ‘no’ branch back to block 204 where the another transaction record may be processed. However, when the tool 128 qualifies a transaction, either because it meets a rate or interval criteria, or is selected at random, execution follows the ‘yes’ branch to block 210. A trigger may then be executed that applies the award to the transaction, based on the award amount specified via the portal 132. The trigger may be a custom set of instructions that are executed at a point in the transaction processing chain, for example, at an issuer 112. The code, when executed, may cause the issuer 112 to apply the award amount to the current transaction and log an amount of the award so that the sponsor can be billed according to the terms of the campaign. In other embodiments, the trigger may cause one or more fields to be appended to the transaction record that cause a downstream entity to recognize the exception and redirect the transaction processing to an alternate processing path.

In an embodiment, the transaction amount may be reduced to zero, that is, making the purchase free to the customer initiating the transaction. In other embodiments, the amount of the award may be less than the full value of the transaction while in some cases the award amount may be greater than the transaction value so that an actual monetary reward is realized above the value of the transaction. As discussed above, the range of award amounts and values of any bonus amounts may be defined using the portal 132 when entering the initial campaign details.

At block 212, after the award is applied, the adjusted value may be reported while the customer is at the point of sale or executing an online order. The award may be reported in real time, which in this embodiment means in the time span of the transaction processing from when the customer enters payment data to when the customer receives a confirmation either during an online transaction or at a point of sale device 102 in a brick and mortar store. In various embodiments, the award may be applied at the award processor 110 and a message sent to a sponsor or other ecosystem partner 102, 104, 106, 108, 110, 112 for providing the actual notification of the award to the customer. The updated transaction amount may be sent to the merchant 104 and the point-of-sale device 102. In an embodiment, the response to the merchant 104 and point-of-sale device 102 may include code that changes the operation of a merchant terminal 194 or point-of-sale device 102 for the purpose of completing and documenting the award made to the customer. This may include notification that the seller may be eligible for an award as well, discussed below.

Optionally, at block 214, an amount of the award, and any fees associated with operating the service may be charged back to the sponsor of the campaign depending on the actual terms of the campaign. In an embodiment, the charges may be reconciled in batch, or the award amounts and fees may be billed out at the time each award is presented. For example, if a restaurant is sponsoring a ride-sharing company campaign, when a passenger receives an award, for example, waiving the ride-sharing fee, the restaurant may be billed for the cost of the ride. In the case of a shared cost campaign, the appropriate portions may be billed to the restaurant and the ride-sharing company as co-sponsors.

In other embodiments, additional awards may be made to the sponsor or other supporting ecosystem partner to provide an additional incentive per the terms of a given campaign. As above, the cost of the additional award incentives may be billed to the campaign sponsor.

Customers, sponsors and supporting ecosystem partners 102, 104, 106, 108 and 112 benefit from the system and method described above. The customer receives a monetary award for doing something they would likely do anyway. The supporting ecosystem partners increase traffic and may also receive a monetary benefit. The sponsor builds goodwill among the customers and merchants/service providers that builds the sponsor's brand and creates loyalty. Using the tools available, the campaign may be designed to impact a highly targeted group of customers, increasing the value of the marketing spend.

Among the technical effects in the portal 132 are the configuration of the platform and its user interface to provide criteria options and receive selections of the criteria used to operate a campaign. The portal is reusable among different campaign sponsors and eliminates the need for technical staff to programmatically define campaign criteria for each sponsor. Technical effects in the award processor 110 include the evaluation in real time of transaction records against first a qualification criteria and secondly the use of the variable ratio selection tool 128 to determine the selection of a particular transaction record for further award processing.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of variably selecting from qualifying purchase transactions, the method comprising:
establishing criteria for transaction record selection via a portal configuration tool;
receiving transaction records with elements including a transaction date and time, a card identifier, a transaction amount, a merchant identifier and geographic location information;
comparing one or more elements of the transaction records to the criteria to create a subset of transactions meeting the criteria;
selecting, from the subset of transaction records, transaction records for an award according to a non-random algorithm;
recording the result of the selection and information corresponding to the subset of transactions including a total number of transaction records meeting the criteria, a date-time range information, and geographic information; and
triggering fulfillment of the award for the selected transaction records.

2. The method of claim 1, wherein the non-random selection algorithm selects transaction records from the subset of transactions according to a ratio of transactions in the subset of transactions.

3. The method of claim 1, wherein the non-random selection algorithm selects transaction records from the subset of transactions according to an interval since the last transaction record selection.

4. The method of claim 1, wherein the portal configuration tool includes a user interface that presents the criteria for transaction record selection and a selection of the non-random algorithm.

5. The method of claim 1, wherein establishing the criteria comprises receiving at least one of a time period over which to perform the selection of transaction records, a value of a qualifying transaction, one or more participating sponsors, a minimum spend amount, or the non-random selection algorithm.

6. The method of claim 1, further comprising selecting a method for an award sponsor to fund the award.

7. The method of claim 1, selecting a value of the award.

8. The method of claim 7, wherein selecting the value of the award comprises selecting the value of the award according to a predetermined distribution of award values.

9. A system for selecting a transaction for an award based on non-random selection during a campaign, the system comprising:
an input that receives a plurality of transaction records;
a memory that stores executable instructions and data;
a processor that executes the executable instructions stored in the memory;
wherein the data stored in the memory includes one or more criteria used to qualify a subset of transaction records from the plurality of transaction records, and wherein the executable instructions cause the processor to:
select a transaction record from the subset of transaction records using a non-random algorithm; and
an output that triggers an award in real time corresponding to the selected transaction record.

10. The system of claim 9, further comprising a portal server, the portal server including:
a portal display that presents options related to the criteria used to qualify the transaction record; and
a portal input that receives a first selection corresponding to one of a date range for the campaign and a minimum spend for the campaign.

11. The system of claim 9, wherein the award amount is selected according to a predetermined award distribution criteria.

12. The system of claim 11, wherein a minimum value of the award is equal to a minimum transaction value required to qualify the transaction record.

13. The system of claim 9, further comprising a point of sale terminal including an input device for receiving transaction credentials and a terminal display that notifies a user of one of the award amount or the reduced transaction amount.

14. The system of claim 13, further comprising a merchant terminal that notifies a merchant of the award amount.

15. A method of making an award corresponding to a purchase transaction comprising:
receiving a transaction record;
determining, at a transaction server, that the transaction record meets a selection criteria;
adding the selected transaction record to a subset of transaction records including additional transaction records that meet the criteria;
selecting a first transaction record from the subset of transaction records according to a variable selection criteria;
selecting an award amount associated with the selected transaction record;
recording data about the subset; and
triggering an award corresponding to the selected transaction record in an amount equal to the selected award amount.

16. The method of claim 15, further comprising:
receiving the transaction from a point-of-sale device.

17. The method of claim 15, wherein determining that the transaction record meets the criteria comprises determining that the transaction record corresponds to a minimum transaction value and falls within a date range corresponding to an award campaign.

18. The method of claim 15, wherein selecting the award amount comprises selecting an award amount ranging between a minimum and the transaction amount according to a predetermined distribution of award amounts.
